(19) United States
(12) Patent Application Publication
(10) Pub. No.: US 2002/0125310 A1
(43) Pub. Date: Sep. 12, 2002

(54) Method for credit card notification

(75) Inventor: Klaus Kursawe, Rueschlikon (CH)

Correspondence Address: IBM CORPORATION, T.J. WATSON RESEARCH CENTER, P.O. BOX 218, YORKTOWN HEIGHTS, NY, 10598, US

(73) Assignee: IBM

(21) Appl. No.: 09/683,972

(22) Filed: Mar. 7, 2002

(30) Foreign Application Priority Data
Mar. 8, 2001 (EP) 01810239.2

(51) Int. Cl. G06K 5/00

(52) U.S. Cl. 235/380

(57) ABSTRACT

In accordance with the present invention, there is provided a method of providing information indicative of an account status to an account holder via a device connected to a network. The method includes the steps of: comparing an actual value with a preset parameter; deriving the information in response to a transaction that influences the actual value; and providing the information to the account holder through the device.

### BACKGROUND OF INVENTION

The present invention relates to a method of informing an account holder. More particularly, the invention relates to a method of informing the account holder about a status of his credit card account.

Today's life without credit cards is nearly unthinkable. The payment of a ticket via the phone or purchasing goods via the Internet are only some examples where credit cards are helpful and needed. A credit card can be defined as a plastic card having a number and a coded magnetic stripe. The card, when signed, entitles its bearer to a revolving line of credit, whose size and interest rate are determined by the borrower's income and credit report. Credit cards began in the late '40s when banks began giving out paper certificates that could be used like cash in local stores. The first real credit card was issued in 1951 by Franklin National Bank in New York.

Shopping around and using one credit card at many places shows the drawback that the card holder has no overview on the amount of money actually spent. A receipt is not printed in any case and can also be lost. A trusted person can have an extra credit card that being billed by the same card holder's account. An abuse of the cards can only be detected once receiving the bill, which is only sent to the card holder within a regular time interval.

In view of the above, a substantial need exists for a method and system in which an account holder can communicate with an account related transaction and remotely control the authorization or denial thereof contemporaneous with and based on circumstances surrounding the transaction.

### SUMMARY OF INVENTION

In accordance with an aspect of the present invention, a method of providing information indicative of an account status to an account holder via a device connected to a network, comprising the steps of, comparing an actual value with a preset parameter; initiating the information in response to a transaction that influences the actual value; and providing the information to the account holder through the device.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF DRAWINGS

Preferred embodiments of the invention are described in detail below, by way of example only, with reference to the following schematic drawings.

FIG. 1 shows a schematic illustration of setting a parameter.

FIG. 2 shows a schematic illustration of a credit card usage.

FIG. 3a shows a schematic illustration of providing information to an account holder in response to the credit card usage.

FIG. 3b shows another schematic illustration of providing information to the account holder in response to the credit card usage.

FIG. 3c shows another schematic illustration of providing information direct to the account holder in response to the credit card usage.

### DETAILED DESCRIPTION

From the above the advantage can be derived that the account holder, e.g., of a credit card, is informed about the account status and has an overview on money actually spent. Moreover, an abuse can be detected immediately and not after receiving a bill or checking the account status.

A parameter can be set by the account holder. This shows the advantage that several types of account usage can be detected, whereby the account holder is informed accordingly. The parameter can comprise a limit. For example, if the amount spent is $500 before the limit is reached, the event will be to notify the account holder. As another example, an expense larger than $1000 could request the account holder to confirm, e.g. by requesting a password, in order to protect the account by abuse.

The parameter can comprise a region. This shows the advantage that the card can only be used within a defined territory or state. For example, all usage of the credit card outside a defined state will be notified to the account holder to detect abuse. Moreover, it is advantageously if different parameters can be set, because then the account holder can protect its account as desired.

The received information can comprise rendering the information. This has the advantage that the account holder is informed immediately. The rendering of the information can comprise confirming the information, e.g. by a personal identification number (PIN), or requesting a password. This has the advantage, that a potential account usage has to be verified by the account holder and can only be performed if the account holder agrees.

The step of transmitting the information via the network and receiving the information by the device can comprises a wireless communication technique. This can be performed, for example, by using a wireless application protocol (WAP) or a short message system (SMS). However, also a wired communication technique or a mixture can be used, e.g., phone call, e-mail. A suitable device which can be applied for the mentioned wireless communication is a mobile phone, including a WAP phone, a personal digital assistant (PDA), or any mobile device being able to render the information to the account holder. This shows the advantage, that the account holder can select the way how the information is provided to him.

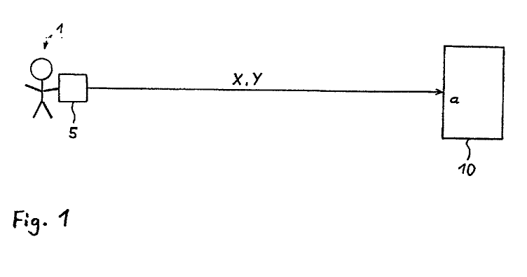

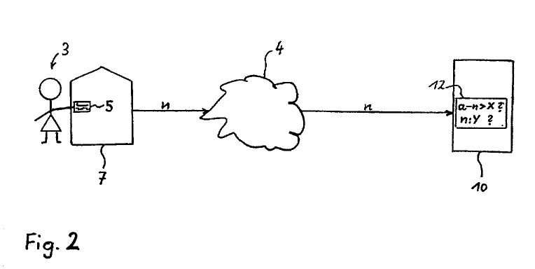

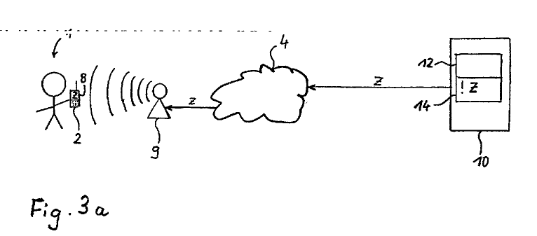

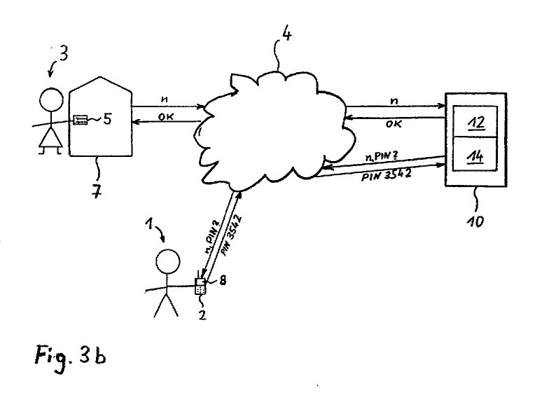

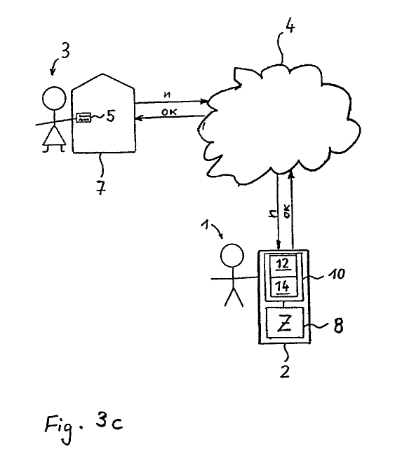

Although the present invention is applicable in a broad variety of account usage applications it will be described with the focus put on a credit card usage application. FIG. 1 shows the setting of a parameter while FIG. 2 shows the credit card usage. FIGS. 3a, 3b, and 3c show examples of providing account relevant information Z to an account holder 1 in response to the credit card usage. In the figures, the same reference numerals are used to denote the same or like parts.

FIG. 1 shows the account holder 1 using an entry device 5, which can be a computer, a mobile phone, or a telephone for example. The entry device 5 is connected to an account server 10, for example via a network 4. The account server 10 is operated by a bank or a credit card company. The account server 10 calculates and stores an actual value a of the account of the account holder 1. This means, whenever a usage of a credit card belonging to the account holder's account is realized by the account server 10, the actual value a is calculated and adapted according to the amount of usage. FIG. 1 indicates the setting of a parameter X, Y. For that, the account holder 1 enters the parameter X, Y into the entry device 5. Then, the parameter X, Y is transmitted via the network 4 to the account server 10 where the parameter X, Y is stored. The parameter X, Y can comprise information concerning a limit, a region or place, a selected shop or shopping area, a company, a time or date, or anything else which is suitable to inform or protect the account holder 1 about the credit card usage. The parameter X, Y can be transmitted and entered to the account server 10 by any known technique.

FIG. 2 shows a schematic illustration of a usage of a credit card 5′. This credit card 5′ belongs to the account of the account holder 1. FIG. 2 indicates a credit card user 3 purchasing some goods at a shop 7 and using the credit card S. The shop 7 accepts the credit card 5′ by using a credit-card-processing device (not shown). This credit-card-processing device or the shop 7 is connected via known means to a network 4′. The account server 10 comprising a comparator 12 is also connected to the network 4′. The usage of the credit card 5′ at the shop 7 initiates a connection to the account server 10 by sending a usage relevant information n, e.g. amount, shop address. As soon as the account server 10 receives the usage relevant information n, it derives therefrom account relevant information which is used to inform the account holder 1. This information can be derived by the use of the comparator 12 performing calculation or comparison of the actual value a and the usage relevant information n with the parameter X, Y. If the comparator 12 detects that the parameter X, Y is reached or even an parameter amount is overdrawn, then the account relevant information is generated and sent to the account holder 1 as described with reference to the following figures.

FIG. 3a shows a schematic illustration of providing account relevant information Z, or short information Z, to the account holder 1 in response to the credit card usage. FIG. 3a shows the account server 10 comprising the comparator 12 and an initiator 14. The account server 10 is connected to the network 4 which further is connected to a transmitter 9, e.g. a radio frequency (RF) transmitter. The account holder 2 has a device 2 comprising an information output 8 for receiving and rendering the account relevant information Z. The device 2 can be a mobile or fixed phone, a portable or fixed computer, or any other device suitable to receive and output the account relevant information Z. As indicated with reference to FIG. 2, if the comparator 12 detects that the parameter X, Y is reached or even a parameter amount is overdrawn, then the account relevant information Z is generated. The account relevant information Z is generated by the initiator 14. Some illustrations shall explain this in more detail. For example, if the amount spent is $500 before a limit is reached, the account holder 1 is notified with the account relevant information Z, e.g., “Your account has $500 left”. In that case a first parameter X contains the limit while a second parameter Y contains the information to inform the account holder 1 when the actual value a has a difference of $500 to the limit. In another example, the usage of the credit card 5′ outside a region or state will notify the account holder 1 with the account relevant information Z, e.g., “Your credit card has been used in Switzerland”. In that case the first parameter X contains the region or state. Several parameters can be used independently. In yet another example, an expense larger than $1000 could request a confirmation of the account holder 1 as described in more detail with respect to the following figure.

FIG. 3b depicts another schematic illustration of providing information Z to the account holder 1 in response to the credit card usage. FIG. 3b shows from the left to the right side, the credit card user 3 using the credit card 5′ at the shop 7 which is connected to the network 4′. Connected to the network are also the device 2 of the account holder 1 and the account server 10 comprising the comparator 12 and the initiator 14. Messages are sent via the network 4 as indicated by the labeled arrows. As described with reference to FIG. 2, the usage of the credit card 5′ at the shop 7 initiates a connection to the account server 10 by sending the usage relevant information n. As soon as the account server 10 receives the usage relevant information n, the comparator 12 performs operations in view of the parameter X, Y. Due to the fact that the amount to be paid by the credit card 5′ exceeds the limit set as parameter X, the initiator 14 requests a confirmation form the account holder 1. For that a first message, labeled with n, PIN?, is sent via the network 4′ to the account holder 1. The account holder 1 is informed by the account relevant information Z about the amount via the information output 8 of the device 2 and is requested to confirm this amount by using a personal identification number (PIN) or password. By doing so, a second message, labeled with PIN 3542, is sent back via the network 4′ to the account server 10 as indicated by the respective arrows. When the account server 10 receives the confirmation from the account holder 1 confirming the amount n, then the account server 10 sends an approval message, labeled with OK, via the network 4′ back to the shop 7. The purchase can now be completed.

FIG. 3c shows another schematic illustration of providing information Z direct to the account holder 1 in response to the credit card usage. In this embodiment, the operations at the comparator 12 and the initiator 14 are performed within the device 2. The account relevant information Z is presented by the information output 8 to the account holder 1 for information and confirmation purposes. The information output 8 can be a display or any suitable output for providing the account relevant information Z to the account holder 1. The usage of the credit card 5′ at the shop 7 in a state initiates a direct connection via the network 4′ to the device 2 of the account holder 1 by sending the usage relevant information n. As soon as the device 2 receives the usage relevant information n, the comparator 12 performs operations in view of the parameter X, Y whereby the initiator 14 requests a confirmation of the purchase at the shop 7 form the account holder 1, because the state has been restricted by setting the appropriate parameter X. The account relevant information Z, for example, “Your credit card is currently used in a restricted state” is displayed to the account holder 1 via the information output 8. The confirmation triggers an approval message, labeled with OK, which is then sent via the network 4 to the shop 7. The purchase can now be completed.

The present invention can be realized in hardware, software, or a combination of hardware and software. Any kind of computer system, or other apparatus adapted for carrying out the method described herein. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

The method can be derived the advantage that the account holder, e.g., of a credit card, is informed about the account status and has an overview on money actually spent. Moreover, an abuse can be detected immediately and not after receiving a bill or checking the account status.

Now that the invention has been described by way of embodiments, various modifications and improvements will occur to those skilled in the art.

1. A method of providing information (Z) indicative of an account status to an account holder via a device connected to a network, comprising the steps of:
comparing an actual value (a) with a preset parameter;
deriving the information (Z) in response to a transaction (n) that influences the actual value (a); and
providing the information (Z) to the account holder through the device.

2. Method according to claim 1 further comprising the steps of transmitting the information (Z) via the network and receiving the information (Z) by the device.

3. Method according to claim 1 further comprising the step of setting the parameter.

4. Method according to claim 3 wherein the step of setting the parameter comprises a limit.

5. Method according to claim 3, wherein the step of setting the parameter comprises a region.

6. Method according to claim 1 further comprising the step of setting different parameters.

7. Method according to claim 2, wherein the step of receiving the information (Z) comprises rendering the information (Z).

8. Method according to claim 7, wherein the step of rendering the information (Z) comprises confirming the information (Z).

9. Method according to claim 2, wherein the step of receiving the information (Z) comprises requesting a password.

10. Method according to claim 2, wherein the step of transmitting the information (Z) via the network and receiving the information (Z) by the device comprises a wireless communication technique.

11. A computer program comprising a program code for performing a method of providing information (Z) indicative of an account status to an account holder via a device connected to a network and when said program is run on a computer, comprising the steps of:
comparing an actual value (a) with a preset parameter;
deriving the information (Z) in response to a transaction (n) that influences the actual value (a); and
providing the information (Z) to the account holder through the device.

12. A computer program product comprising program code means stored on a computer readable medium for performing an operation when said program product is run on a computer, said program code means comprising:
a comparator for comparing an actual value (a) with a preset parameter;
an initiator for deriving the information (Z) in response to a transaction (n) that influences the actual value (a); and
an information output indicating the information (Z) to the account holder.

13. A system of providing information (Z) indicative of an account status to an account holder via a device connected to a network, the system comprising:
a comparator for comparing an actual value (a) with a preset parameter;
an initiator for deriving the information (Z) in response to a transaction (n) that influences the actual value (a); and
an information output indicating the information (Z) to the account holder.

14. The system according to claim 13, wherein the device is a mobile device.
